(19) United States
(12) Patent Application Publication
(10) Pub. No.: US 2012/0001883 A1
(43) Pub. Date: Jan. 5, 2012

(54) METHOD AND APPARATUS FOR CALCULATING A POWER CONSUMPTION SEGMENT AND DISPLAYING A POWER CONSUMPTION INDICATOR

(75) Inventor: Sasu Tarkoma, Helsink (FI)

(73) Assignee: Nokia Corporation

(21) Appl. No.: 12/828,682

(22) Filed: Jul. 1, 2010

(51) Int. Cl. G09G 5/00

(52) U.S. Cl. 345/211

(57) ABSTRACT

An apparatus may include a power consumption calculator configured to calculate a power consumption segment for a function performed by the apparatus or a component of the apparatus. A power consumption mapping module may be configured to provide for display of a power consumption indicator defining a graphical characteristic, for example a size or color, corresponding to the power consumption segment. Further, a power consumption adjuster and/or the power consumption mapping module may provide for selection of the power consumption indicator to thereby interact with the power consumption segment, such as by adjusting the power consumption segment or providing for display of a power consumption sub-segment indicator corresponding to a power consumption sub-segment.

### TECHNOLOGICAL FIELD

Embodiments of the present invention relate generally to displaying power consumption indicators and, more particularly, relate to an apparatus, method and a computer program product configured to calculate a power consumption segment and provide for display of a power consumption indicator defining a graphical characteristic corresponding to the power consumption segment.

### BACKGROUND

In order to provide easier or faster information transfer and convenience, telecommunication industry service providers are continually developing improvements to existing communication networks. As a result, wireless communication has become increasingly more reliable in recent years. Along with the expansion and improvement of wireless communication networks, mobile terminals used for wireless communication have also been continually improving. In this regard, due at least in part to reductions in size and cost, along with improvements in battery life and computing capacity, mobile terminals have become more capable, easier to use, and cheaper to obtain. Due to the now ubiquitous nature of mobile terminals, people of all ages and education levels are utilizing mobile terminals to communicate with other individuals or contacts, receive services and/or share information, media and other content.

With the proliferation of mobile terminals, and given the variety of services beyond just placing phone calls that can be accomplished with mobile terminals, many individuals are finding mobile terminals to be important parts of their work and social lives. Thus, being able to rely upon the availability of the mobile terminal is an important consideration for many users. However, since mobile terminals may run on battery power, and since the number of functions they can perform are often numerous, battery conservation is a constant concern for mobile terminal users and therefore balancing use of the mobile terminal with power consumption becomes an issue. In this regard, for example, if a user is waiting for a bus or an airplane and wants entertainment, or if a user is lost or has an accident in a remote location, the user would almost certainly like to have as much battery power available as possible despite the fact that the user may have been utilizing the mobile terminal for routine functions and tasks in the meantime. Thus, the saving of battery power is important.

To improve battery life, of course, better batteries could be produced. However, the way in which a device is operated may also influence battery life. Accordingly, many operational factors have been modified in order to assist in increasing battery life. However, prior battery saving techniques have not provided users with easily understandable information regarding power consumption and the desired level of control over the balance between user terminal functionality and battery life.

### BRIEF SUMMARY

A method, apparatus and computer program product are therefore provided that calculate a power consumption segment and provide for display of a power consumption indicator, thereby allowing a user to conveniently view and interact with the power consumption of an apparatus.

In an example embodiment, an improved apparatus comprises at least one processor and at least one memory including computer program code, the at least one memory and the computer program code configured to, with the processor, cause the apparatus to calculate a power consumption segment, provide for display of a power consumption indicator defining a graphical characteristic corresponding to the power consumption segment, and provide for selection of the power consumption indicator to interact with the power consumption segment.

In an additional example embodiment a method comprises calculating a power consumption segment via a processor, providing for display of a power consumption indicator defining a graphical characteristic corresponding to the power consumption segment, and providing for selection of the power consumption indicator to interact with the power consumption segment.

In a further example embodiment a computer program product comprises at least one computer-readable storage medium having computer-executable program code portions stored therein, the computer-executable program code portions comprising program code instructions for calculating a power consumption segment, program code instructions providing for display of a power consumption indicator defining a graphical characteristic corresponding to the power consumption segment, and program code instructions providing for selection of the power consumption indicator to interact with the power consumption segment.

Accordingly, embodiments of the present invention may calculate power consumption segments and provide for display of power consumption indicators to thereby facilitate interaction with the power consumption of an apparatus.

### BRIEF DESCRIPTION OF THE SEVERAL VIEWS OF THE DRAWING(S)

Having thus described embodiments of the present disclosure in general terms, reference will now be made to the accompanying drawings, which are not necessarily drawn to scale, and wherein:

FIG. 1 illustrates a schematic block diagram of a system according to an example embodiment of the present invention;

FIG. 2 illustrates a schematic block diagram of an apparatus configured to provide for display of a power consumption indicator corresponding to a power consumption segment according to an example embodiment of the present invention;

FIG. 3 illustrates the user terminal of FIG. 1 when the user terminal embodies the apparatus of FIG. 2 and the user terminal is providing for display of power consumption indicators corresponding to functions which the user terminal is configured to perform according to an example embodiment of the present invention;

FIG. 4 illustrates the user terminal of FIG. 3 when the user terminal is providing for display of a plurality of power consumption sub-segment indicators corresponding to power consumption sub-segments according to an example embodiment of the present invention;

FIG. 5 illustrates the user terminal of FIG. 1 when the user terminal embodies the apparatus of FIG. 2 and the user terminal is providing for display of power consumption indicators corresponding to components of the user terminal according to an example embodiment of the present invention; and

FIG. 6 illustrates a flowchart of the operations performed in calculating a power consumption segment and providing for display of a power consumption indicator in accordance with an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

As used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

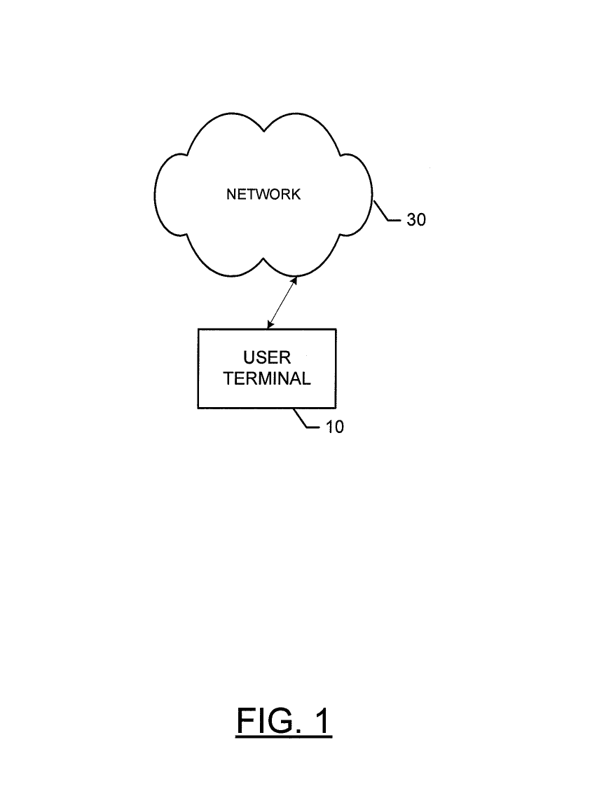

As indicated above, embodiments of the present invention may be employed in methods, apparatuses and computer program products configured to calculate a power consumption segment and provide for display of a power consumption indicator defining a graphical characteristic corresponding to the power consumption segment. In this regard, for example, FIG. 1 illustrates a block diagram of a system that may benefit from embodiments of the present invention. It should be understood, however, that the system as illustrated and hereinafter described is merely illustrative of one system that may benefit from embodiments of the present invention and, therefore, should not be taken to limit the scope of embodiments of the present invention.

As shown in FIG. 1, an embodiment of a system in accordance with an example embodiment of the present invention may include a user terminal 10. The user terminal 10 may be any of multiple types of fixed or mobile communication and/or computing devices such as, for example, portable digital assistants (PDAs), pagers, mobile televisions, mobile telephones, gaming devices, laptop computers, personal computers (PCs), cameras, camera phones, video recorders, audio/video players, radios, global positioning system (GPS) devices, or any combination of the aforementioned, and other types of voice and text communications systems, which employ embodiments of the present invention.

In some embodiments the user terminal 10 may be capable of communicating with other devices, either directly, or via a network 30. The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. Thus, the network 30 may be a cellular network, a mobile network and/or a data network, such as a local area network (LAN), a metropolitan area network (MAN), and/or a wide area network (WAN), for example, the Internet. In turn, other devices such as processing elements (for example, personal computers, server computers or the like) may be included in or coupled to the network 30. By directly or indirectly connecting the user terminal 10 and the other devices to the network 30, the user terminal and/or the other devices may be enabled to communicate with each other, for example, according to numerous communication protocols including Hypertext Transfer Protocol (HTTP) and/or the like, to thereby carry out various communication or other functions of the mobile terminal and the other devices, respectively. As such, the user terminal 10 and the other devices may be enabled to communicate with the network 30 and/or each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as wireless LAN (WLAN), Worldwide Interoperability for Microwave Access (WiMAX), WiFi, ultra-wide band (UWB), Wibree techniques and/or the like and fixed access mechanisms such as digital subscriber line (DSL), cable modems, Ethernet and/or the like. Thus, for example, the network 30 may be a home network or other network providing local connectivity.

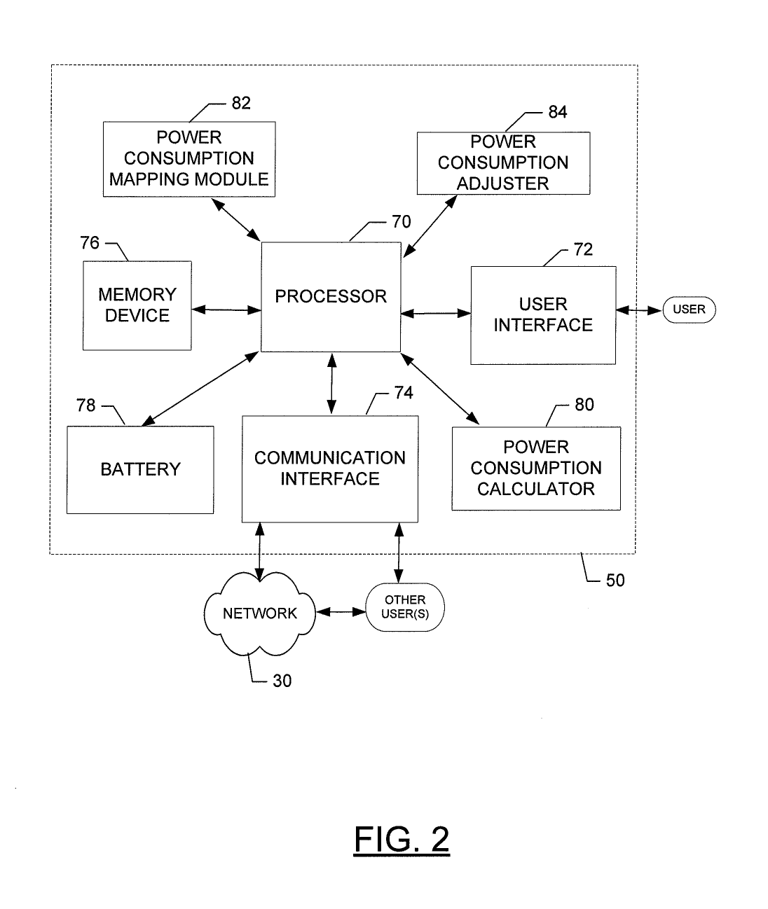

In an example embodiment, an apparatus 50 is provided that may be employed by devices performing example embodiments of the present invention. The apparatus 50 may be embodied, for example, as any device hosting, including, controlling or otherwise comprising the user terminal 10. However, embodiments may also be embodied on a plurality of other devices such as for example where instances of the apparatus 50 may be embodied on the network 30. As such, the apparatus 50 of FIG. 2 is merely an example and may include more, or in some cases less, than the components shown in FIG. 2.

With further regard to FIG. 2, the apparatus 50 is configured to calculate a power consumption segment and provide for display of a power consumption indicator defining a graphical characteristic corresponding to the power consumption segment. The apparatus 50 may include or otherwise be in communication with a processor 70, a user interface 72, a communication interface 74 and a memory device 76. The memory device 76 may include, for example, volatile and/or non-volatile memory. The memory device 76 may be configured to store information, data, files, applications, instructions or the like. For example, the memory device 76 could be configured to buffer input data for processing by the processor 70. Additionally or alternatively, the memory device 76 could be configured to store instructions for execution by the processor 70.

The processor 70 may be embodied in a number of different ways. For example, the processor 70 may be embodied as one or more of various processing means such as a coprocessor, a microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a hardware accelerator, a special-purpose computer chip, or the like. In an example embodiment, the processor 70 may be configured to execute instructions stored in the memory device 76 or otherwise accessible to the processor. Alternatively or additionally, the processor 70 may be configured to execute hard coded functionality. As such, whether configured by hardware or software methods, or by a combination thereof, the processor 70 may represent an entity (for example, physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor to perform the algorithms and/or operations described herein when the instructions are executed. However, in some cases, the processor 70 may be a processor of a specific device (for example, a mobile terminal or network device such as a server) adapted for employing embodiments of the present invention by further configuration of the processor by instructions for performing the algorithms and/or operations described herein. The processor 70 may include, among other things, a clock, an arithmetic logic unit (ALU) and logic gates configured to support operation of the processor. In some embodiments the processor 70 may run an operating system configured to execute the applications.

Meanwhile, the communication interface 74 may be any means such as a device or circuitry embodied in either hardware, software, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (for example, network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet, High-Definition Multimedia Interface (HDMI) or other mechanisms. Furthermore, the communication interface 74 may include hardware and/or software for supporting communication mechanisms such as BLUETOOTH®, Infrared, UWB, WiFi, and/or the like, which are being increasingly employed in connection with providing home connectivity solutions.

The user interface 72 may be in communication with the processor 70 to receive an indication of a user input at the user interface and/or to provide an audible, visual, mechanical or other output to the user. As such, the user interface 72 may include, for example, a keyboard, a mouse, a joystick, a display, a touch screen, a microphone, a speaker, a ringer or other input/output mechanisms.

The processor 70 may comprise user interface circuitry configured to control at least some functions of one or more elements of the user interface 72, such as, for example, the speaker, the ringer, the microphone, the display, and/or the like. The processor 70 and/or user interface circuitry comprising the processor may be configured to control one or more functions of one or more elements of the user interface 72 through computer program instructions (for example, software and/or firmware) stored on a memory accessible to the processor (for example, memory device 76, and/or the like).

In some embodiments the apparatus 50 may include a battery 78, or other power supply. Although the apparatus 50 and associated method and computer program products are generally described herein as being applicable to embodiments in which the power supply may be depleted, in other embodiments the power supply may be substantially capable of powering the apparatus for an unlimited duration. For example, in some embodiments the power supply may comprise a commercial power supply such that electricity is provided by a commercial power plant via power lines. Thus, embodiments may be applicable to applications in which energy consumption is of concern, regardless of the capacity of the power supply.

Accordingly, in some embodiments the apparatus 50 may include a power consumption calculator 80. The processor 70 may be embodied as, include or otherwise control the power consumption calculator 80. The power consumption calculator 80 may employ or embody logic which calculates the power consumption level of the apparatus 50 or other device such as the user terminal 10 when embodied therein. Further, the power consumption calculator 80 may be configured to calculate one or more power consumption segments. Power consumption segments, as used herein, refer to portions of the total power consumption of the device. For example, in some embodiments power consumption segments may be calculated by the power consumption calculator 80 for various functions performed by the device. For example, as will be described below, in some embodiments functions may include voice calls, web browsing, audio playback, etc. Additionally or alternatively power consumption segments may be calculated by the power consumption calculator 80 for one or more components of the device. For example, as will also be described below, in some embodiments components may include 3G components, user interface components, such as the user interface 72, and memory such as the memory device 76. Thus, components may refer to hardware components of the device embodying the apparatus 50 in some embodiments.

Further, the power consumption calculator 80 may calculate the power consumption segments in terms of power consumption of currently active components/functions and/or past power consumption of components/functions, and in either case the power consumption may in some embodiments be calculated as an average. Further, in some embodiments, the power consumption calculator 80 may calculate predicted power consumption of the device. Predicted power consumption segments may, for example, be based on current and/or past power consumption levels of the components of the device and/or the functions performed by the device. Additionally, in some embodiments the power consumption calculator 80 may be configured to calculate the remaining operating time for the device which may be, for example, based on the past power consumption levels of the device. Further, the power consumption calculator 80 may be configured to calculate the remaining operating time for the device based on operation of the device using a certain component or function. For example, the power consumption calculator 80 may in some embodiments calculate the remaining operating time for the device based on use of the device in a voice call mode. Calculations by the power consumption calculator 80 relating to remaining operating time may be based on the present power level of the battery 78, which may in some embodiments be calculated by the power consumption calculator or a separate device.

In some embodiments the apparatus 50 may further include a power consumption mapping module 82. The processor 70 may be embodied as, include or otherwise control the power consumption mapping module 82. The power consumption mapping module 82 may be configured to provide for display of a power consumption indicator defining a graphical characteristic corresponding to a power consumption segment. Accordingly, as will be described below, the apparatus 50 may provide a user with a visual representation of power consumption.

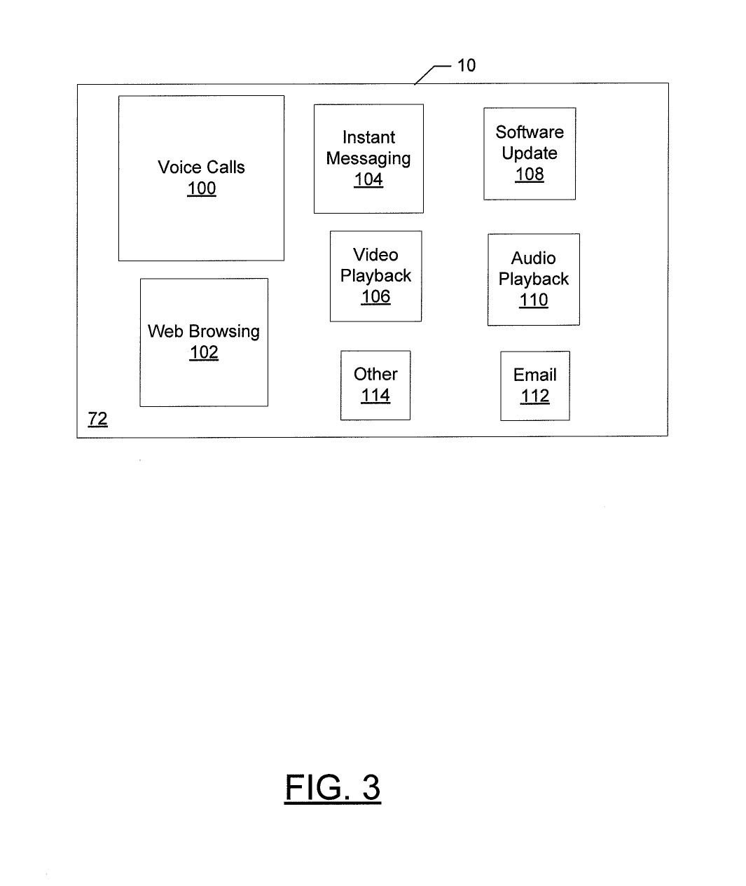

In this regard, FIGS. 3-5 illustrate embodiments of the user terminal 10 when it embodies the apparatus 50. In particular, the user terminal 10 is illustrated as comprising the user interface 72, which as described above may comprise a display and in some embodiments the user interface may be configured to receive user inputs. For example, the user interface 72 may comprise a touch screen.

FIG. 3 illustrates the user terminal 10 when the user interface 72 is displaying a plurality of power consumption indicators 100-114. In particular, the power consumption indicators 100-114 correspond to functions which the user terminal 10 is configured to perform. For example, the user interface 72 is illustrated as displaying voice call 100, web browsing 102, instant messaging 104, video playback 106, software update 108, audio playback 110, email 112, and other 114 power consumption indicators. As previously indicated, the power consumption mapping module 82 is configured to provide for display of power consumption indicators 100-114 defining graphical characteristics corresponding to respective power consumption segments.

In this regard, the power consumption mapping module 82 may provide for output of a tree map of the power consumption indicators. Thereby, for example, the size (e.g., area), color, and/or other graphical characteristic of the power consumption indicators 100-114 may be selected by the power consumption mapping module 82 to correspond with the respective power consumption segments. Thus, for example, FIG. 3 illustrates the voice calls power consumption indicator 100 as being the largest power consumption indicator, and hence the voice calls power consumption indicator may correspond to the largest power consumption segment of the displayed functions. However, as noted above, the graphical characteristics may additionally or alternatively comprise the color of the power consumption indicators. In this regard, for example, shades of red may be used to illustrate greater power consumption and shades of green may be used to illustrate lesser power consumption.

In addition to displaying the power consumption indicators 100-114, the user terminal 10 may also provide for selection of the power consumption indicators 100-114 to thereby allow the user to interact with the respective power consumption segments. For example, the user may interact with a power consumption segment by selecting one of the power consumption indicators in order to receive more information regarding the selected power consumption indicator. Thus, by way of example, when the a power consumption indicator is selected, the user terminal 10 may provide for display of a power consumption sub-segment indicator defining a sub-segment graphical characteristic corresponding to the power consumption sub-segment. For example, the power consumption mapping module 82 may create a new tree map displaying power consumption sub-segment indicators.

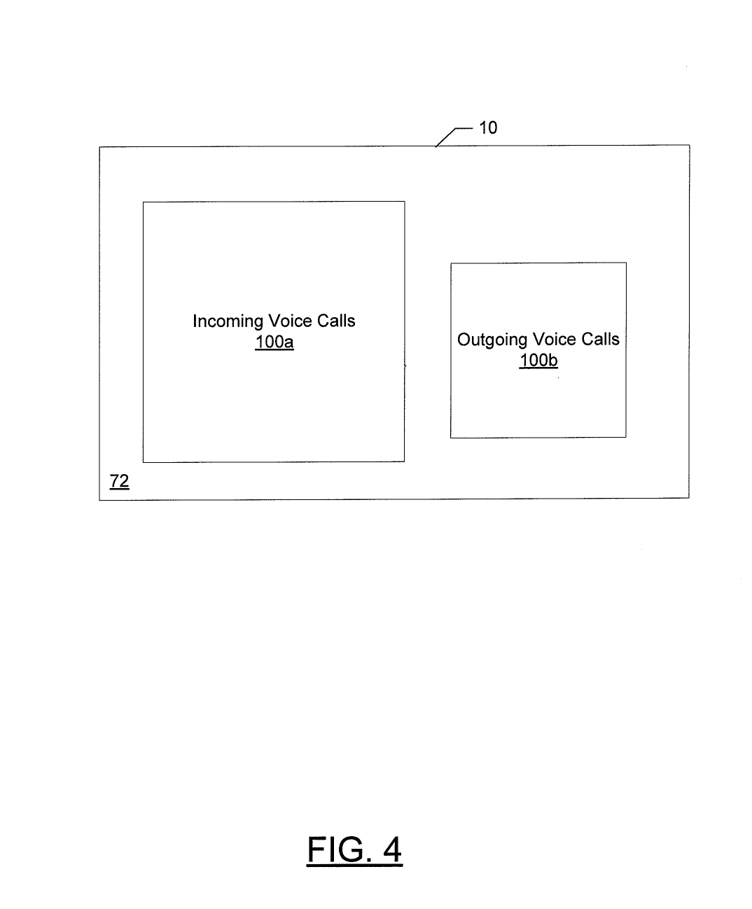

In this regard, FIG. 4 illustrates the user terminal 10 after the voice calls power consumption indicator 100 from FIG. 3 has been selected. As illustrated, the user terminal 10 may provide the user with more information regarding the selected power consumption indicator in some embodiments. Thus, by way of example, when the voice calls power consumption indicator 100 from FIG. 3 is selected, the user terminal 10 may break down the voice calls power consumption indicator into incoming voice calls 100a and outgoing voice calls 100b power consumption sub-segment indicators. Similarly to the above-described power consumption indicators 100-114, the power consumption sub-segment indicators 100a, 100b may define sub-segment graphical characteristics corresponding to respective power consumption sub-segments. For example, the sub-segment graphical characteristics may include the size or color of the power consumption sub-segment indicators, which may be selected, for example, based on present power consumption or remaining operating time. However, the power consumption sub-segments indicators may display various other types and forms of data relating to the power consumption sub-segments in substantially the same manner as described above with respect to power consumption segments and corresponding power consumption indicators. In the illustrated embodiment, the incoming voice calls power consumption sub-segment indicator 100a is larger than the outgoing voice calls power consumption sub-segment indicator 100b. Thus, for example, this embodiment may illustrate that incoming voice calls have consumed more power than outgoing voice calls in the past. Accordingly, the user terminal 10 may provide for selection of power consumption indicators to thereby interact with the power consumption segments, such as by displaying information regarding power-consumption sub-segments as illustrated in FIG. 4.

Thus, as noted above, the user terminal 10 may provide for selection of a power consumption indicator. Further, in some embodiments the user terminal 10 may provide for selection of a power consumption indicator by zooming in on a portion of the displayed power consumption indicators for example by using hand gestures. Thereby the user terminal 10 may display power consumption sub-segment indicators corresponding to one of the power consumption indicators. However, in some embodiments, the user terminal 10 may be configured to zoom in such that multiple power consumption indicators are selected. Thereby power consumption sub-segment indicators corresponding to multiple power consumption indicators may be displayed in some embodiments at the same time. Further, in some embodiments the user terminal 10 may be configured to display both power consumption indicators and power consumption sub-segment indicators at the same. Thus, in some embodiments a recursive tree map algorithm may be employed such that nested power consumption sub-segment indicators are displayed at the same time power consumption indicators are employed.

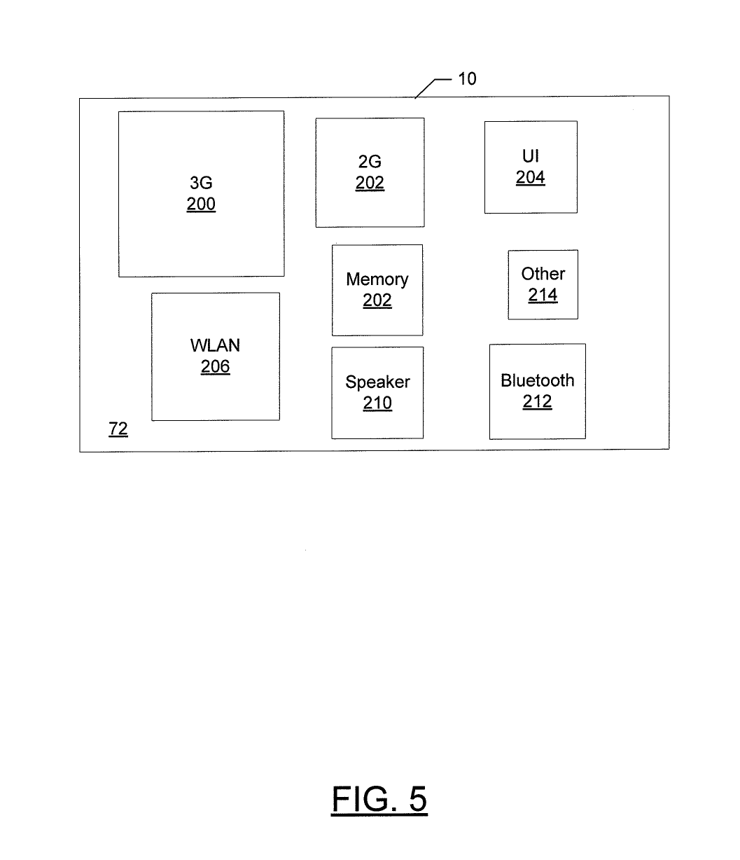

FIGS. 3-4 relate to displaying power consumption indicators for power consumption segments which are functions the user terminal 10 is configured to perform. However, as preciously noted, the power consumption calculator 80 may additionally or alternatively be configured to calculate power consumption segments for components of the user terminal 10 or other device in which the apparatus 50 is embodied. In this regard, FIG. 5 illustrates the user terminal 10 when the user interface 72 is displaying power consumption indicators for components of the user terminal 10 as provided by the power consumption mapping module 82. In particular, the user interface is displaying 3G 200, 2G 202 user interface (UI) 204, wireless local area network (WLAN) 206, memory 208, speaker 210, Bluetooth 212, and other 214 power consumption indicators.

As previously discussed, the power consumption mapping module 82 may provide for display of the power consumption indicators 200-214 defining graphical characteristics corresponding to the respective power consumption segments. In this regard, for example, the power consumption mapping module 82 may provide the power consumption indicators which correspond to greater power consumption segments with larger sizes than those power consumption indicators corresponding to lesser power consumption segments. Accordingly, for example, in the embodiment illustrated in FIG. 5, the larger size of the 3G power consumption indicator 200 may indicate that the 3G power consumption segment is greater than the remaining power consumption segments 202-214. However, as described above, various other graphical characteristics may be used to distinguish between the various power consumption segments associated with the power consumption indicators.

Additionally, as indicated above, the power consumption calculator 80 may in some embodiments calculate the remaining operating time for the device. The power consumption calculator 80 may also be configured to calculate the remaining operating time for the device corresponding to performance of a particular function or use of a particular component. In this regard the power consumption mapping module 82 may be configured to display the remaining operating time for the user terminal 10. For example, power consumption calculator 82 may provide for display of a power consumption indicator for audio playback which is larger than the power consumption indicator for video playback. In such instances, the graphical characteristic may comprise the size of the power consumption indicators, and a larger size may correspond to a greater remaining operating time. Accordingly, for example, a larger power consumption indicator for audio playback may allow a user to see that use of audio playback functionality may allow for greater remaining operating time as compared to use of video playback functionality before the battery 78 depletes.

Further, in some embodiments the power consumption calculator 80 may be configured to predict expected power consumption segments as described above. In this regard, for example rather than showing current or past power consumption, the power consumption indicators 100-114, 200-214 may correspond to expected power consumption segments. For example, returning to FIG. 3, the displayed power consumption indicators 200-214 may correspond to expected power consumption segments. Therefore, by way of example, the larger size of the voice calls power consumption indicator 100 may indicate that the power consumption calculator 80 predicts that the voice call function will be the largest power consumption segment for the user terminal 10. In some embodiments the power consumption calculator 80 may thereby be used to predict upcoming power usage for the device, which may be, for example, based on past power consumption.

In an exemplary embodiment (not shown), the power consumption calculator 80 may be configured to calculate a power consumption segment which predicts expected power consumption based on, for example, historical data stored in, or collected from, the apparatus 50. For example, when an audio playback application plays a song, the power consumption calculator 80 may be able to calculate the average consumption during playback of the song and store this information in memory or send this information to a network server for storing. The average power consumption may also be calculated over longer periods of time of playing music (e.g. last playlist played, hours of the day, or a specified time period). Power consumption segments which predict expected power consumption may also be calculated for any other application or function performed by the apparatus 50. The power consumption indicators may additionally or alternatively show textually or graphically the remaining expected power, for example ‘Battery power left to play 100 songs,’ or for example display bolded chord symbols which indicate the estimated remaining power for audio playback or other function.

Returning to FIG. 2, the apparatus 50 may further comprise a power consumption adjuster 84 in some embodiments. The processor 70 may be embodied as, include or otherwise control the power consumption adjuster 84. The power consumption adjuster 84 may be configured to adjust one or more power consumption segments. Thus, a user may be able to interact with power consumption segments through obtaining additional information regarding the power consumption segments as described above and/or through adjusting the power consumption segments. In this regard, for example, the user terminal 10 or other device embodying the apparatus 50 may be configured to provide for selection of a power consumption indicator in order to interact with a power consumption segment. By way of example, with regard to FIG. 3, the user terminal 10 may be configured such that a user may use the user interface 72 to select one or more of the power consumption indicators 100-114 to adjust the corresponding power consumption segments.

Adjusting the power consumption segments may be conducted in a variety of manners in various embodiments. For example, the power consumption adjuster 84 may allow a user to prioritize or schedule processes performed by the user terminal 10. Prioritization may instruct the user terminal 10 to conserve energy other than for the selected processes/components. For example, if the user wants to prioritize voice calls and instant messaging, the user may select the voice calls 100 and instant messaging 104 power consumption indicators. Accordingly, the power consumption adjuster 84 may adjust the power consumption levels of the remaining processes performed by the user terminal 10. Thus, for example, audio playback may be limited to a reduced volume and the user terminal 10 may check for email messages less often. As may be understood by one having ordinary skill in the art, various other adjustments to the functions and/or components of the user terminal 10 may occur.

However, as mentioned above, adjustment of power consumption segments may in some embodiments allow a user to schedule performance of a function or use of a component of the user terminal 10. For example, the user may prefer to wait to update software on the user terminal 10 at some point other than during the day when the user would prefer to preserve the battery 78 for other uses. Accordingly, with regard to FIG. 3, selection of the software update power consumption indicator 108 may allow the user to adjust the corresponding power consumption segment relating to updating software by scheduling software updates to occur at night. In other embodiments the power consumption adjuster 84 may additionally or alternatively be configured to adjust the power consumption segments by scheduling the performance of selected functions and/or usage of selected components to occur when the user terminal 10 is connected to a battery charger. Thereby, for example, a user may delay the performance of certain functions and/or usage of certain components until the battery 78 is charging.

In another exemplary embodiment, the apparatus 50 may allow the user to interact with the power consumption segments in other manners. By way of example, if the user is watching a movie played by a video playback application, and the power consumption calculator 80 has predicted that the battery 78 of the apparatus 50 may run out during watching the video, the apparatus may notify the user by displaying a message, for example, which indicates that ‘Device battery may last for 15 more minutes. Recharge the battery or decrease network power segments. Decrease now?’ After which, the user may be presented with the option to adjust the power consumption segments, or if so configured, the apparatus 50 may adjust the power consumption segments automatically, for example, by prioritization which may be based on default settings or user selectable settings, or based on historical statistical data. The apparatus 50 may also decrease the power consumption segments and/or power reserved for other functions based on historical data, and/or as needed. For example, if during video playback, the network connection is enabled for web browsing, the apparatus 50 may disconnect this network connection, thus preserving power for the video playback. The apparatus 50 may utilize the historical data and application/network usage patterns and adjust running applications accordingly. For example, if during video playback the user has not accepted calls in the past, the apparatus 50 may decrease the power needed for the stand-by network connection.

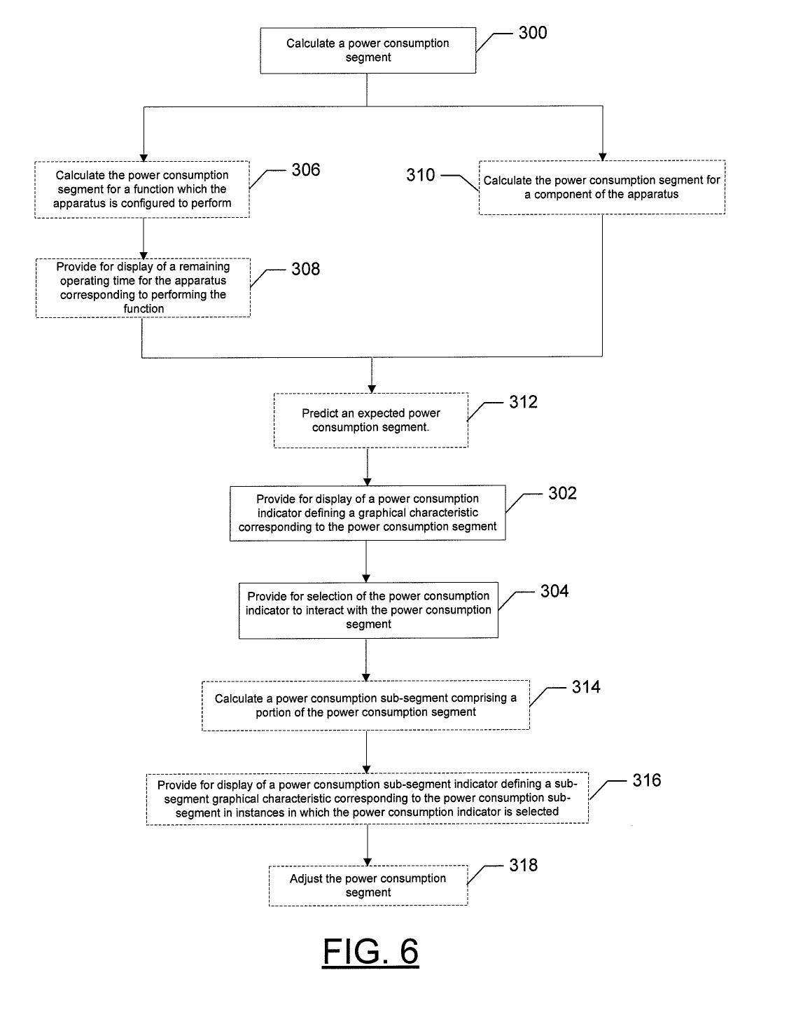

In terms of methods associated with embodiments of the present invention, the above-described apparatus 50 or other embodiments of apparatuses may be employed. In this regard, FIG. 6 is a flowchart of a system, method and program product according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by a computer program product including computer program instructions. In this regard, the computer program instructions which embody the procedures described above may be stored by a memory device and executed by a processor of an apparatus. As will be appreciated, any such computer program instructions may be loaded onto a computer or other programmable apparatus (for example, hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In this regard, one embodiment of a method comprises calculating a power consumption segment at operation 300. Further, the method may include providing for display of a power consumption indicator defining a graphical characteristic corresponding to the power consumption segment at operation 302. Additionally, the method may include providing for selection of the power consumption indicator to interact with the power consumption segment at operation 304.

In some embodiments, certain ones of the above-described operations (as illustrated in solid lines in FIG. 6) may be modified or further amplified. In some embodiments additional operations may also be included (some examples of which are shown in dashed lines in FIG. 6). It should be appreciated that each of the modifications, optional additions or amplifications may be included with the above-described operations (300-304) either alone or in combination with any others among the features described herein. As such, each of the other operations as will be described herein may be combinable with the above-described operations (300-304) either alone or with one, more than one, or all of the additional operations in any combination.

For example, the method may further comprise calculating the power consumption segment for a function which the apparatus is configured to perform at operation 306. Accordingly, in some embodiments of the method the power consumption segment may relate to a function performed by the apparatus. In such embodiments the method may further comprise providing for display of a remaining operating time for the apparatus corresponding to performing the function at operation 308. However, in other embodiments the power consumption segment may relate to a component of the apparatus. Thus, the method may comprise calculating the power consumption segment for a component of the apparatus at operation 310.

Regardless of whether the power consumption segment is calculated for a function performed by the apparatus or a component of the apparatus, the method may further comprise predicting an expected power consumption segment at operation 312. Further, the method may include calculating a power consumption sub-segment comprising a portion of the power consumption segment at operation 314. The method may in some embodiments also comprise providing for display of a power consumption sub-segment indicator defining a sub-segment graphical characteristic corresponding to the power consumption sub-segment in instances in which the power consumption indicator is selected at operation 316. Further, some embodiments of the method may comprise adjusting the power consumption segment at operation 318.

In an example embodiment, an apparatus for performing the method of FIG. 6 and other methods described above may comprise a processor (for example, the processor 70) configured to perform some or each of the operations (300-318) described above. The processor may, for example, be configured to perform the operations (300-318) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 300-318 may comprise, for example, the processor 70, the user interface 72, the communication interface 74, the power consumption calculator 80, the power consumption mapping module 82, the power consumption adjuster 84, and/or an algorithm executed by the processor for processing information as described above. However, the above-described portions of the apparatus 50 as they relate to the operations of the method illustrated in FIG. 6 are merely examples, and it should be understood that various other embodiments may be possible.

In some embodiments the operation 300 of calculating a power consumption segment may be conducted by means, such as the power consumption calculator 80, and/or the processor 70. Further, the operation 302 of providing for display of a power consumption indicator defining a graphical characteristic corresponding to the power consumption segment may be conducted by means, such as user interface 72, the power consumption mapping module 82, and/or the processor 70. Additionally, the operation 304 of providing for selection of the power consumption indicator to interact with the power consumption segment may be conducted by means, such as the user interface 72, the power consumption mapping module 82, and/or the processor 70.

Further, the operation 306 of calculating the power consumption segment for a function which the apparatus is configured to perform and the operation 310 of calculating the power consumption segment for a component of the apparatus may be conducted by means, such as the user interface 72, the power consumption calculator 80, and/or the processor 70. Also, the operation 308 of providing for display of a remaining operating time for the apparatus corresponding to performing the function may be conducted by means, such as the user interface 72, the power consumption mapping module 82, and/or the processor 70. Additionally, the operation 312 of predicting an expected power consumption segment and the operation 314 of calculating a power consumption sub-segment comprising a portion of the power consumption segment may be conducted by means, such as power consumption calculator 80, and/or the processor 70. Further, the operation 316 of providing for display of a power consumption sub-segment indicator defining a sub-segment graphical characteristic corresponding to the power consumption sub-segment may be conducted by means, such user interface 72, the power consumption mapping module 82, and/or the processor 70. Also, the operation 318 of adjusting the power consumption segment may be conducted by means, such as the power consumption adjuster 84 and/or the processor 70.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one memory including computer program code, the at least one memory and the computer program code configured to, with the processor, cause the apparatus to:
calculate a power consumption segment;
provide for display of a power consumption indicator defining a graphical characteristic corresponding to the power consumption segment; and
provide for selection of the power consumption indicator to interact with the power consumption segment.

2. The apparatus of claim 1, further comprising user interface circuitry configured to:
facilitate user control of at least some functions of the apparatus through use of a display; and
cause at least a portion of a user interface of the apparatus to be displayed on the display to facilitate user control of at least some functions of the apparatus.

3. The apparatus of claim 1, further configured to calculate the power consumption segment for a function which the apparatus is configured to perform.

4. The apparatus of claim 3, further configured to display a remaining operating time for the apparatus corresponding to performance of the function.

5. The apparatus of claim 1, further configured to calculate the power consumption segment for a component of the apparatus.

6. The apparatus of claim 1, further configured to calculate a power consumption sub-segment comprising a portion of the power consumption segment; and
provide for display of a power consumption sub-segment indicator defining a sub-segment graphical characteristic corresponding to the power consumption sub-segment in instances in which the power consumption indicator is selected.

7. The apparatus of claim 1, further configured to adjust the power consumption segment.

8. A method, comprising:
calculating a power consumption segment via a processor;
providing for display of a power consumption indicator defining a graphical characteristic corresponding to the power consumption segment; and
providing for selection of the power consumption indicator to interact with the power consumption segment.

9. The method of claim 8, further comprising calculating the power consumption segment for a function which the apparatus is configured to perform.

10. The method of claim 9, further comprising providing for display of a remaining operating time for the apparatus corresponding to performing the function.

11. The method of claim 8, further comprising calculating the power consumption segment for a component of the apparatus.

12. The method of claim 8, further comprising calculating a power consumption sub-segment comprising a portion of the power consumption segment; and
providing for display of the of a power consumption sub-segment indicator defining a sub-segment graphical characteristic corresponding to the power consumption sub-segment in instances in which the power consumption indicator is selected.

13. The method of claim 8, further comprising adjusting the power consumption segment.

14. The method of claim 8, further comprising predicting an expected power consumption segment.

15. A computer program product comprising at least one computer-readable storage medium having computer-executable program code portions stored therein, the computer-executable program code portions comprising:
program code instructions for calculating a power consumption segment;
program code instructions providing for display of a power consumption indicator defining a graphical characteristic corresponding to the power consumption segment; and
program code instructions providing for selection of the power consumption indicator to interact with the power consumption segment.

16. The computer program product of claim 15, further comprising program code instructions for calculating the power consumption segment for a function which the apparatus is configured to perform.

17. The computer program product of claim 16, further comprising program code instructions providing for display of a remaining operating time for the apparatus corresponding to performance of the function.

18. The computer program product of claim 15, further comprising program code instructions for calculating the power consumption segment for a component of the apparatus.

19. The computer program product of claim 15, further comprising program code instructions for calculating a power consumption sub-segment comprising a portion of the power consumption segment; and
program code instructions providing for display of a power consumption sub-segment indicator defining a sub-segment graphical characteristic corresponding to the power consumption sub-segment in instances in which the power consumption indicator is selected.

20. The computer program product of claim 15, further comprising program code instructions for adjusting the power consumption segment.
